(19) United States
(12) Patent Application Publication
(10) Pub. No.: US 2022/0067800 A1
(43) Pub. Date: Mar. 3, 2022

(54) INTELLIGENT EVIDENCE BASED RESPONSE SYSTEM

(71) Applicant: International Business Machines Corporation, Armonk, NY (US)

(72) Inventors: Lee A. Carbonell, Flower Mound, TX (US); Tsz S. Cheng, Grand Prairie, TX (US); Jeff Edgington, Fort Worth, TX (US); Pandian Mariadoss, Allen, TX (US)

(21) Appl. No.: 17/003,230

(22) Filed: Aug. 26, 2020

(51) Int. Cl. G06Q 30/02; G06N 20/00

(52) U.S. Cl. CPC G06Q 30/0282; G06N 20/00

(57) ABSTRACT

A system for generating responses to operational feedback is provided. A computing device identifies operational feedback directed towards an entity. The computing device determines a context for the operational feedback, wherein the context includes a plurality of features relating to the operational feedback. The computing device retrieves operational data associated with the entity, wherein the operational data corresponds to points in time that are within a predetermined time frame of the context. The computing device evaluates the context and the operational data against a quality of service attribute of the entity. The computing device generates a positive response towards the operational feedback based, at least in part, on the evaluating, wherein the context and the operational data are indicative of an anomaly in the quality of service attribute.

### BACKGROUND OF THE INVENTION

The present invention relates generally to the field of operational feedback, and more particularly to using computational techniques to provide context-based responses to operational feedback.

In general, consumers leverage customer feedback for consumer products or service purchases. Often, consumers prefer providers with high approval ratings and positive reviews. However, a single aggregated rating or an accumulation of ratings from subsequent reviews reflect poorly on a business entity or corporation.

### SUMMARY

Embodiments of the present invention provide a method, system, and program product for a system for responses to customer-based feedback.

A first embodiment encompasses a method for generating responses to operational feedback. One or more processors identify operational feedback directed towards an entity. One or more processors determine a context for the operational feedback, wherein the context includes a plurality of features relating to the operational feedback. One or more processors retrieve operational data associated with the entity, wherein the operational data corresponds to points in time that are within a predetermined time frame of the context. One or more processors evaluate the context and the operational data against a quality of service attribute of the entity. One or more processors generate a positive response towards the operational feedback based, at least in part, on the evaluating, wherein the context and the operational data are indicative of an anomaly in the quality of service attribute.

A second embodiment encompasses a computer program product for generating responses to operational feedback. The computer program product includes one or more computer readable storage media and program instructions stored on the one or more computer-readable storage media. The program instructions include program instructions to identify operational feedback directed towards an entity. The program instructions include program instructions to determine a context for the operational feedback, wherein the context includes a plurality of features relating to the operational feedback. The program instructions include program instructions to retrieve operational data associated with the entity, wherein the operational data corresponds to points in time that are within a predetermined time frame of the context. The program instructions include program instructions to evaluate the context and the operational data against a quality of service attribute of the entity. The program instructions include program instructions to generate a positive response towards the operational feedback based, at least in part, on the evaluating, wherein the context and the operational data are indicative of an anomaly in the quality of service attribute.

A third embodiment encompasses a computer system for generating responses to operational feedback. The computer system includes one or more computer processors, one or more computer-readable storage media, and program instructions stored on the computer-readable storage media for execution by at least one of the one or more processors. The program instructions include program instructions to identify operational feedback directed towards an entity. The program instructions include program instructions to determine a context for the operational feedback, wherein the context includes a plurality of features relating to the operational feedback. The program instructions include program instructions to retrieve operational data associated with the entity, wherein the operational data corresponds to points in time that are within a predetermined time frame of the context. The program instructions include program instructions to evaluate the context and the operational data against a quality of service attribute of the entity. The program instructions include program instructions to generate a positive response towards the operational feedback based, at least in part, on the evaluating, wherein the context and the operational data are indicative of an anomaly in the quality of service attribute.

### BRIEF DESCRIPTION OF THE SEVERAL VIEWS OF THE DRAWINGS

FIG. 1 is a functional block diagram illustrating a computing environment, in which a system generates responses to customer-based reviews, in accordance with an exemplary embodiment of the present invention.

FIG. 2 illustrates operational processes of executing a system for analyzing customer feedback, on a computing device within the environment of FIG. 1, in accordance with an exemplary embodiment of the present invention.

FIG. 3 illustrates operational processes of executing a system for generating a response and an internal report, on a computing device within the environment of FIG. 1, in accordance with an exemplary embodiment of the present invention.

FIG. 4 depicts a cloud computing environment according to at least one embodiment of the present invention.

FIG. 5 depicts abstraction model layers according to at least on embodiment of the present invention.

FIG. 6 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While some solutions for responding to customer-based feedback are known, these solutions may be inadequate to proactively generate positive responses to negative customer-based reviews that refute frivolous negative reviews. Generally, past, present, and future customers search and review online review sites before receiving services by a business entity. Additionally, a single aggregated rating or an accumulation of reviews from past reviewers may not reflect the current performance of a business entity. Embodiments of the present invention provide a solution that proactively analyzes and identifies customer-based reviews that contain negative content related to a commercial product, commercial service or business entity. Embodiments of the present invention further provide a solution that generates a response profile for the negative customer-based review. Additionally, if the system is unable to generate a response profile for the negative customer-based review, the system generates an internal report highlighting the negative customer-based reviews and the operational data associated with the customer-based review.

The present invention will now be described in detail with reference to the Figures.

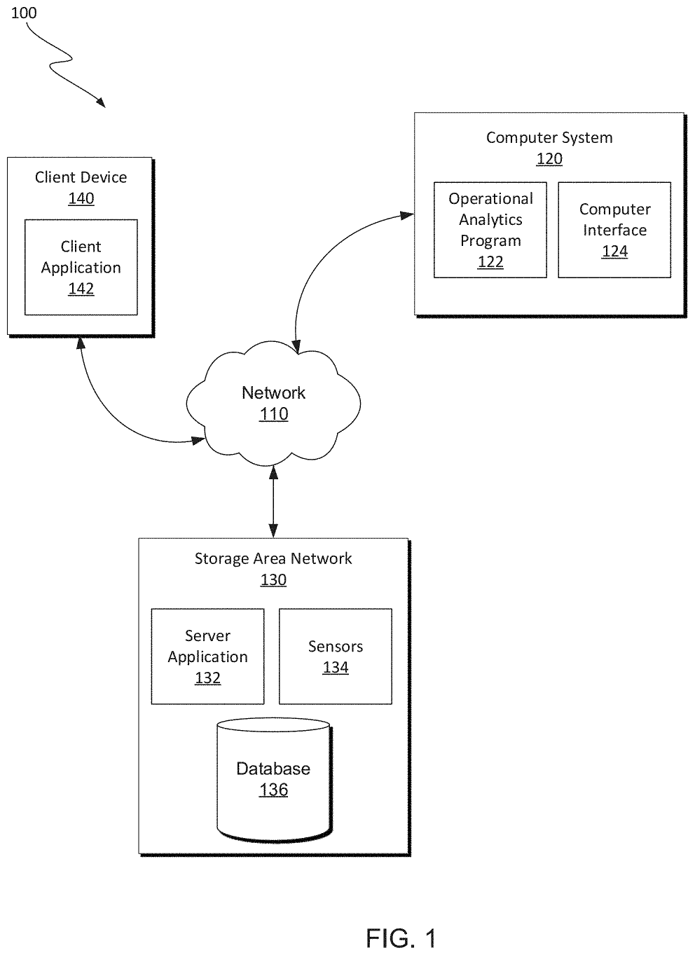

FIG. 1 is a functional block diagram illustrating computing environment, generally designated 100, in accordance with one embodiment of the present invention. Computing environment 100 includes computer system 120, storage area network 130, and client device 140 connected over network 110. Computer system 120 includes operational analytics program 122 and computer interface 124. Storage area network (SAN) 130 includes server application 132, sensors 134, and database 136. Client device 140 includes client application 142.

In various embodiments of the present invention, computer system 120 is a computing device that can be a standalone device, a server, a laptop computer, a tablet computer, a netbook computer, a personal computer (PC), a personal digital assistant (PDA), a desktop computer, a smart phone, a mobile device, or any programmable electronic device capable of receiving, sending, and processing data. In general, computer system 120 represents any programmable electronic device or combination of programmable electronic devices capable of executing machine readable program instructions and communications to act as a single pool of seamless resources. In general, computer system 120 can be any computing device or a combination of devices with access to various other computing systems (not shown) and is capable of executing operational analytics program 122 and computer interface 124. Computer system 120 may include internal and external hardware components, as described in further detail with respect to FIG. 1.

In this exemplary embodiment, operational analytics program 122 and computer interface 124 are stored on computer system 120. However, in some embodiments, operational analytics program 122 and computer interface 124 are stored externally and accessed through a communications network, such as network 110. Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between computer system 120, SAN 130, client device 140, and various other computer systems (not shown), in accordance with a desired embodiment of the present invention.

In various embodiments of the present invention, the various other computer systems (not shown) can be a standalone device, a server, a laptop computer, a tablet computer, a netbook computer, a personal computer (PC), a desktop computer, or any programmable electronic device capable of receiving, sending, and processing data. In another embodiment, the various other computer systems represent a computing system utilizing clustered computers and components to act as a single pool of seamless resources. In general, the various other computer systems can be any computing device or combination of devices with access to computer system 120, SAN 130, client device 140 and network 110 and is capable executing operational analytics program 122 and computer interface 124. The various other computer systems (not shown) may include internal and external hardware components, as described in further detail with respect to FIG. 1.

In the embodiment depicted in FIG. 1, operational analytics program 122, at least in part, has access to server application 132 and can communicate data stored on computer system 120 to SAN 130, client device 140, and various other computer systems (not shown). More specifically, operational analytics program 122 defines a user of computer system 120 that has access to data stored on SAN 130.

Operational analytics program 122 is depicted in FIG. 1 for illustrative simplicity. In various embodiments of the present invention, operational analytics program 122 represents logical operations executing on computer system 120, where computer interface 124 manages the ability to view these logical operations that are managed and executed in accordance with operational analytics program 122. In some embodiments, operational analytics program 122 represents a cognitive AI system that processes and analyzes input and output (I/O). Additionally, operational analytics program 122, when executing cognitive AI processing, operations to learn from the I/O that was analyzed and generates (i) a feedback response and (ii) an internal notification based, at least, on the analyzation operation. In some embodiments, operational analytics program 122 determines whether a specific action is likely to take place and generates (i) a feedback response and (ii) an internal notification and communicates the response and notification to SAN 130.

Computer system 120 includes computer interface 124. Computer interface 124 provides an interface between computer system 120 and SAN 130. In some embodiments, computer interface 124 can be a graphical user interface (GUI) or a web user interface (WUI) and can display text, documents, web browser, windows, user options, application interfaces, instructions for operation, and includes the information (such as graphic, text, and sound) that a program presents to a user and the control sequences the user employs to control the program. In some embodiments, computer system 120 accesses data communicated from SAN 130 via a client-based application that runs on computer system 120. For example, computer system 120 includes mobile application software that provides an interface between computer system 120 and SAN 130.

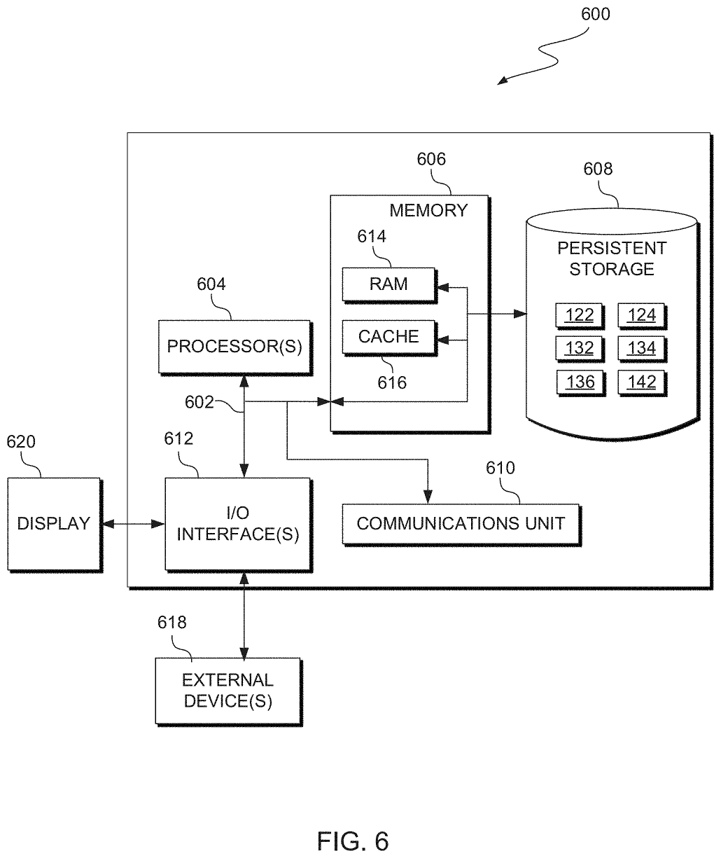

Storage area network (SAN) 130 is a storage system that includes server application 132, sensors 134, and database 136. SAN 130 may include one or more, but is not limited to, computing devices, servers, server-clusters, web-servers, databases and storage devices. SAN 130 operates to communicate with computer system 120 and various other computer systems (not shown) over a network, such as network 110. For example, SAN 130 communicates with operational analytics program 122 to transfer data between, but is not limited to, computer system 120 and various other computer systems (not shown) that are connected to network 110. Additionally, SAN 130 communicates with client application 142 to receive one or more customer-based reviews from client device 140 over network 110. Embodiments of the present invention recognize that the one or more customer-based reviews are also referred to as operational feedback, wherein the operational feedback includes, but is not limited to, data associated with various reviews associated with various commercial products or commercial services provided by customers of client device 130. SAN 130 can be any computing device or a combination of devices that are communicatively connected to a local IoT network, i.e., a network comprised of various computing devices including, but are not limited to, computer system 120 to provide the functionality described herein. SAN 130 can include internal and external hardware components as described with respect to FIG. 6. Embodiments of the present invention recognize that FIG. 1 may include any number of computing devices, servers, databases, and/or storage devices, and the present invention is not limited to only what is depicted in FIG. 1. As such, in some embodiments, some or all of the features and functions of SAN 130 are included as part of computer system 120 and/or another computing device. Similarly, in some embodiments, some of the features and functions of computer system 120 are included as part of SAN 130 and/or another computing device.

Additionally, in some embodiments, SAN 130 represents, or is part of, a cloud computing platform. Cloud computing is a model or service delivery for enabling convenient, on demand network access to a shared pool of configurable computing resources (e.g., networks, network bandwidth, servers, processing, memory, storage, applications, virtual machines, and services(s)) that can be rapidly provisioned and released with minimal management effort or interaction with a provider of a service. A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model, and can be implemented as various deployment model including as a private cloud, a community cloud, a public cloud, and a hybrid cloud.

In various embodiments, SAN 130 is depicted in FIG. 1 for illustrative simplicity. However, it is to be understood that, in various embodiments, SAN 130 can include any number of databases that are managed in accordance with the functionality of server application 132. In general, database 136 represents data and server application 132 represents code that provides an ability to take specific action with respect to another physical or virtual resource and manages the ability to use and modify the data. In an alternative embodiment, operational analytics program 122 can also represent any combination of the aforementioned features, in which server application 132 has access to database 136. To illustrate various aspects of the present invention, examples of server application 132 are presented in which operational analytics program 122 represents one or more of, but is not limited to, a local IoT network and contract event monitoring system.

In some embodiments, server application 132 and database 136 are stored on SAN 130. However, in another embodiment, server application 132 and database 136 may be stored externally and accessed through a communication network, such as network 110, as discussed above.

In one embodiment of the present invention, operational analytics program 122 generates a feedback response and an internal report for computer system 120, where computer system 120 has access to customer-based reviews on SAN 130 and has access to customer-based reviews on other computer systems, such as client device 140 (e.g., various other computing devices).

In various embodiments, SAN 130 represents an internet-based service for storing and transcribing operational data and/or electronic documents. In various embodiments, SAN 130 encompasses software, servers, databases, webservers, and webpages supported by software to operate and maintain an internet-based service for information sharing. Users of computer system 120 and/or various other computer systems (not shown) have access to databases maintained and supported by SAN 130 via any communicative connection known in the art. One or more users have the availability to edit, change, or alter datasets stored on SAN 130 and are accessible by any communication connection known in the art.

In various embodiments depicted in FIG. 1, operational analytics program 122 obtains data related to customer-based reviews from SAN 130, client device 140, and/or various other computer systems (not shown). In various embodiments, customer-based reviews data represent various reviews associated with various commercial products or commercial services. Additionally, the customer-based review data includes data of one or more components associated with various commercial products or commercial services.

In various embodiment of the present invention, a user of client device 140 (hereinafter “customer”) generates a customer-based review and communicates the review to a database (e.g., database 136 executing on SAN 130). In various embodiments, the customer-based review is associated with a specific individual for whom the costumer-based review data is associated with. In various embodiments, the customer-based review is associated with one or a combination of: (i) one or more individuals, (ii) one or more elements of the commercial product or commercial service, and (iii) one or more threshold levels of experiences. Client application 142 generates one or more customer-based reviews based on, but not limited to, the customer wishes and communicates the customer-based review to database 136, wherein, server application 132 executing on SAN 130 generates a compilation of customer-based reviews.

In various embodiments of the present invention, a customer of client device 140 utilizing client application 142 generates a customer-based review associated with an experience with a commercial product or commercial service manufactured and/or provided by the business entity (e.g., computer system 120). Embodiments of the present invention provide that computer system 120 is also referred to herein as entity. In some embodiments, the customer-based review is uploaded to a public webpage review site, wherein customers provide reviews and feedback regarding their experiences with the business entities commercial product and/or commercial services. In some embodiments, the customer-based review is uploaded to a webpage owned and operated by the business entity (e.g., SAN 130). The present invention recognizes that server application 132 requests the customer-based reviews from client application 142 or from the public webpage review site that the customer-based review was uploaded to and server application 132 stores the one or more customer-based reviews on database 136. In an alternative embodiment, client application 142 communicates the customer-based review to server application 132.

In various embodiments of the present invention, operational analytics program 122 communicates with server application 132 and requests the one or more customer-based reviews (e.g., operational feedback) stored on database 136. In various embodiments, operational analytics program 122 analyzes the one or more customer-based reviews received from server application 132. Operational analytics program 122 identifies one or a combination of: (i) the commercial product and/or commercial service, (ii) one or more elements of the commercial product or commercial service, (iii) the quality of the feedback (e.g., positive feedback, negative feedback, or neutral feedback), and (iv) the quantitative value of the feedback (e.g., a rating system, ranking system, etc.).

In various embodiments of the present invention, one or more customer-based reviews include a description and/or commentary associated with a customer's experience with the commercial product or commercial service. Additionally, this description and/or commentary further discusses one or more specific elements related to the commercial product and/or commercial service and further identifies each element discussed within the one or more customer-based reviews.

Embodiments of the present invention recognize that operational analytics program 122 analyzes the one or more customer-based reviews and identifies the quantitative value of the feedback associated with the one or more customer-based reviews. In various embodiments of the present invention, operational analytics program 122 identifies a value associated with the commercial product and/or commercial service (e.g., a rating out of five or 10 denoted as X/5 or X/10, wherein the “X” represents the value provided by the customer, etc.). Additionally, operational analytics program 122 identifies individual ratings for one or more elements associated with the commercial product and/or commercial services. Operational analytics program 122 stores this data on computer system 120. In some embodiments, operational analytics program 122 communicates this data to SAN 130 and the data is stored on database 136.

In various embodiments, operational analytics program 122 actively monitors for one or more customer-based reviews associated with one or more commercial products and/or services. Operational analytics program 122 aggregates the one or more customer-based reviews for one or more commercial products and/or commercial services. Additionally, operational analytics program 122 further aggregates the ratings associated with the one or more customer-based reviews and weights the average ratings associated with the one or more customer-based reviews and weighs the average rating associated with one or a combination of: (i) overall average rating of the commercial product and/or commercial service, (ii) average rating for one or more components associated with the commercial product and/or commercial service, and (iii) similar elements associated with the one or more commercial products and/or commercial services.

Embodiments of the present invention recognize that operational analytics program 122 receives the one or more customer-based reviews and analyzes the reviews to identify one or a combination of: (i) the commercial product and/or commercial service, (ii) one or more elements of the commercial product or commercial service, (iii) the quality of the feedback (e.g., positive feedback, negative feedback, or neutral feedback), and (iv) the quantitative value of the feedback (e.g., a rating system, ranking system, etc.). In various embodiments, operational analytics program 122 identifies, but is not limited to, (i) the quality and (ii) the quantity of each individual customer-based review. In various embodiments, the feedback associated with the customer-based review can be one or a combination of positive, negative, or neutral feedback. In various embodiments, operational analytics program 122 determines whether the feedback is one or a combination of positive, negative or neutral feedback. The present invention recognizes that operational analytics program 122 generates a response profile to each individual customer-based review. In various embodiments, if operational analytics program 122 determines that a customer-based review provided positive feedback, operational analytics program 122 generates a response profile thanking the customer for their patronage, In various embodiments, if operational analytics program 122 determines that a customer-based review provided negative feedback, operational analytics program 122 generates (i) a response profile thanking the customer for their patronage and offering an avenue to report the negative feedback or (ii) a response profile that articulates a positive response that refutes the alleged negative feedback based on, but is not limited to operational data received from sensors 134.

In various embodiments, operational analytics program 122 analyzes one or more customer-based reviews. In various embodiments, operational analytics program 122 determines that the quality and quantitative value of the feedback is positive based on, but not limited to, the content of the message. In various embodiments, operational analytics program 122 utilizes natural language processing (NPL), image processing, machine visions, and machine learning to analyze the content of the review which includes one or a combination of: (i) text, (ii) images, or (iii) rating or ranking system. In response to analyzing the content of the review, operational analytics program 122 generates a response profile associated with the positive analyzed customer-based review. In various embodiments, the response profile includes one or a combination of: (i) the customer's online handle, (ii) a message thanking the customer for their patronage, or (iii) a response associated with the content of the customer-based review. In various embodiments, operational analytics program 122 communicates the response profile to server application 132 with a set of program instructions instructing server application 132 to post the response profile to the subsequent public webpage review site. In some embodiments, the set of program instructions instructing server application 132 to communicate the response profile to client device 130.

In various embodiments, operational analytics program 122 analyzes one or more customer-based reviews. In various embodiments, operational analytics program 122 determines that the quality and quantitative value of the feedback is negative based on, but not limited to, the content of the message. In various embodiments, operational analytics program 122 utilizes natural language processing (NPL), image processing, machine vision, and machine learning to analyze the content of the review which includes one or a combination of: (i) text, (ii) images, or (iii) rating or ranking system. In response to determining that the customer-based review is negative, operational analytics program 122 communicates with server application 132 and requests operational data associated with the customer-based review. In various embodiments, operational data includes one or a combination of: (i) video images of the business entity's security cameras, (ii) electronic documents regarding managerial reports, or (iii) financial transactions. In various embodiments of the present invention, operational analytics program 122 leverages the operational data to measure customer quality issues and feedback and measure the current functional state of the business entity and/or store. In various embodiments, operational analytics program 122 analyzes the operational data and compares the customer-based review to the collected operational data.

In various embodiments, operational analytics program 122 determines that the content of the customer-based review (e.g., operational feedback) is similar to the collected operational data. In some embodiments, operational analytics program 122 determines that an anomaly in the quality of service attribute of the business occurred (e.g., negative experience for a customer). In various embodiments, a negative experience for a customer includes, but is not limited to, long wait times, poor customer service, incorrect amount on a bill, etc. The present invention recognizes that these examples are non-limiting and are not exhaustive. One having ordinary skill in the art would understand that these examples are scenario specific, and that the characteristics of each individual scenario may be viewed differently based on the customer's perception on whether the scenario is positive or negative. Further, embodiments provide an analysis that predicts whether a given characteristic is likely to be associated with or would likely be classified as a positive or negative experience and/or context. In various embodiments, operational analytics program 122 generates a response profile associated with the negative analyzed customer-based review. In various embodiments, the response profile includes one or a combination of: (i) the customer's online handle, (ii) a message thanking the customer for their patronage, or (iii) a response associated with the content of the customer-based review. In some embodiments, the response associated with the content of the customer-based review includes, but is not limited to, apologizing for the negative experience, a statement on how the business entity has corrected the situation to not occur in the subsequent future, etc. The present invention recognizes that these examples are non-limiting and are not exhaustive. One having ordinary skill in the art would understand that these examples are scenario specific, and that the characteristics of each individual scenario may be viewed differently based on the customer's perception on whether the scenario is positive or negative. Additionally, embodiments provide a response that predicts whether a given characteristic is likely to be associated with or would likely be classified as a positive or negative experience and/or context. In various embodiments, operational analytics program 122 communicates the response profile to server application 132 with a set of program instructions instructing server application 132 to post the response profile to the subsequent public webpage review site. In some embodiments, the set of program instructions instructing server application 132 to communicate the response profile to client device 130.

In some embodiments of the present invention, operational analytics program 122 operational analytics program 122 determines that the quality and quantitative value of the feedback is negative based on, but not limited to, the content of the message. In various embodiments, operational analytics program 122 utilizes natural language processing (NPL), image processing, machine visions, and machine learning to analyze the content of the review which includes one or a combination of: (i) text, (ii) images, or (iii) rating or ranking system. In response to determining that the customer-based review is negative, operational analytics program 122 communicates with server application 132 and requests operational data associated with the customer-based review. In various embodiments, operational data includes one or a combination of: (i) video images of the business entity's security cameras, (ii) electronic documents regarding managerial reports, or (iii) financial transactions. In various embodiments of the present invention, operational analytics program 122 leverages the operational data to measure customer quality issues and feedback and measure the current functional state of the business entity and/or store. In various embodiments, operational analytics program 122 analyzes the operational data and compares the customer-based review to the collected operational data. In some embodiments, operational analytics program 122 determines that an anomaly in the quality of service attribute of the business occurred (e.g., negative experience for a customer). However, in various embodiments of the present invention, operational analytics program 122 determines that a response profile cannot be generated. In response to determining that a response profile cannot be generated, operational analytics program 122 generates an internal report. In various embodiments, operational analytics program 122 generates an internal report that includes, one or a combination of: (i) the customer-based review, (ii) one or more operational data associated with the customer-based review, and (iii) an analysis of the quality and quantitative value of the negative feedback. Operational analytics program 122 communicates the internal report to an appointed individual responsible for handling customer quality issues. In some embodiments, operational analytics program 122 stores the internal report on database 136 for subsequent use. One having ordinary skill in the art would understand that an appointed individual responsible for handling customer quality issues is non-limiting nor exhaustive and includes, but is not limited to, a hired professional within the business entity (e.g., human resources, communications director, etc.).

Embodiments of the present invention recognize that operational analytics program 122 communicates with (i) business operations, (ii) customer review feedback channels, and (iii) various subscriptions. In various embodiments of the present invention, operational analytics program 122 subscribes to (i) a review listener agent, wherein the customer-based review is analyzed by a review content deconstruction module that leverages various cognitive services such as sentiment/tone analyzers, personality insights, natural language processors, and machine learning, (ii) a communication hub, (iii) a business model profile and rules, (iv) an operations monitoring and analytics integration framework, (v) an evidence scoring/ranking component, (vi) a positive response builder, and (vii) an unresolved complaint monitor.

In various embodiments of the present invention, the review listener agent manages connections to configured social media channels and public webpage review site and detects new posts and messages that are relevant to the business, and further ingests the content into the system for further processing.

In various embodiments of the present invention, the communications hub communicates notifications to operational analytics program 122 (e.g., the business owners) based on a user-defined set of content and rules. Additionally, operational analytics program 122 determines an appropriate communication mechanism, and broadcasts or communicates a response to the appropriate social media channels or public webpage review site.

In various embodiments of the present invention, the business model profile and rules maintain feedback classifications/models. Additionally, the business model profile and rules define available equipment and operational metrics, allow for creation of new categories/models, and utilize machine learning to adjust automatically. Further, the business model profile and rules configure thresholds and any partial templates for a response profile and determine who/when to send messages from the system.

In various embodiments of the present invention, the operations monitoring and analytics integration framework maintains connections to operational analytics program 122. In various embodiments, the operations monitoring and analytics integration framework also allows for an open interface framework to add a new system and devices for additional data collection. Additionally, the operations monitoring and analytics integration framework gathers data from operational analytics program 122 according to classifications/models that are appropriate for feedback/review.

In various embodiments of the present invention, the evidence scoring/ranking component evaluates sets of data/analysis results against the feedback/customer-based review to validate the content was accurate. The evidence scoring/ranking applies scoring of each evaluation set in its effectiveness against the original complaint and ranks all evaluations to determine the best answer with an applicable rationale.

In various embodiments of the present invention, the positive response builder constructs a response profile based on evidence scoring/ranking operational data that is appropriate based on the context of the customer-based review. The positive response builder, which can be provided as a subscription service, for example, utilizes business rules/models and any relevant partial template and considers tone and sentiment during the construction of the response profile. Additionally, the positive response builder subscription includes operational data artifacts (e.g., video, images, etc.) and summary information, where applicable.

In various embodiments of the present invention, the unresolved complaint monitor tracks positive response profiles for all negative feedback. Additionally, the unresolved complaint monitor internally flags specific posts/messages and social media channels and public webpage review sites where there is outstanding or unresolved negative feedback. When insufficient data exists to form a positive response profile, operational analytics program 122 continues to monitor and evaluate the appropriate operational analytics until there is data that represents an appropriate opportunity to generate a response profile.

Embodiments of the present invention provide for operational analytics program 122 to subscribe to various entities for monitoring and communications. In various embodiments, the listening service through a cloud-based system will monitor popular forms of social media channels and various public webpage reviews sites as configured by the business entity or corporation. In various embodiments, when a new customer-based review is detected by the review listener agent, the customer-based review is analyzed by the review content deconstruction module to understand the customer-based review. In some embodiments the review content deconstruction module leverages various cognitive services such as sentiment/tone analyzer, personality insights, NPL, and machine learning, and categorizes the customer-based review into new or existing business model profiles.

Embodiments of the present invention provide that if the customer-based review is determined to be negative, the system will utilize the operational monitoring and analytics integration framework to connect to the operational analytics program 122 to validate the review and gather the appropriate evidence to refute the customer-based review or collect information that can be used to generate a positive response profile. Each data point of evidence is evaluated by the evidence scoring/ranking module to determine the best fit response profile for each customer-based review.

Embodiments of the present invention provide that an initial response profile is generated by the positive response builder. The response profile includes relevant sensor data (e.g., pictures, wait times, etc.) along with other analytic information that has been evaluated, by the evidence scoring/ranking module, to have the highest/best score in view of the negative customer-based review. In various embodiments, the process is fully automated and does not depend on pre-written templates, but the response profile can be generated based on, but not limited to, business rules established by the business entity or corporation that requires approval or can be modified before responding to the customer-based review.

In various embodiments of the present invention, the business model profile and rules module maps various types of inputs that are relevant to a given category, and how much weight is given to each category for the purposes of scoring/ranking the evaluation of those inputs. In some embodiments, an issue of “wait time” might be identified from the customer-based review, where the business entity or corporation might indicate the camera angles/analytics, transaction logs, and customer feedback filters that help evaluate the “wait time.” Additionally, a positive response profile could be formed based on the inputs that were utilized, with an emphasis on the data and evidence provided from the inputs that was prioritized based on, at least, the business rules. In some embodiments, if no data and evidence is available to indicate a positive response profile, operational analytics program 122 would respond with a template-based interim response while operational analytics program 122 re-evaluates the operations until a positive response profile can be generated.

In various embodiments, the operational analytics program 122 utilizes integrated capabilities of the various subscriptions that include, but are not limited to, (i) operational analytics program 122 understands the customer-based review/feedback and intelligently gather and evaluate the appropriate evidence/information from available operational systems to validate or refute the customer-based review/feedback, (ii) operational analytics program 122 automatically formulates a positive response profile to address the context of the given customer-based review based on, at least, the evidence gathered from the review listener agent and the operations monitoring analytics integration framework, and (iii) when operational analytics program 122 collects data and evidence that validates the customer-based review, but is unable to refute or compose a satisfactory positive response profile, operational analytics program 122 generates an alert to the business entity or corporation about the unresolved and valid customer-based review with recommendations on how to adjust business operations.

Embodiments of the present invention provide that operational analytics program 122 publishes the response profile to the customer-based review to counter the negative review based on, but not limited to, data and evidence to the contrary.

Embodiments of the present invention provide that if operational analytics program 122 determines that the review is valid, but there is no evidence to counter, refute, or positively respond to the customer-based review, operational analytics program 122 will perform one or a combination of the following. In various embodiments, operational analytics program 122 will notify the business entity or corporation of the valid complaint (e.g., open issue) and provide recommendations for operational improvement. In various embodiments, operational analytics program 122 will continuously monitor to look for new or previously undiscovered data and evidence that will counter, refute, or allow for a positive response profile to be generated. In various embodiments, when operational analytics program 122 identifies new evidence that addresses the negative customer-based review, operational analytics program 122 reevaluates the information and reformulates a response profile and communicates the response profile to the customer-based review.

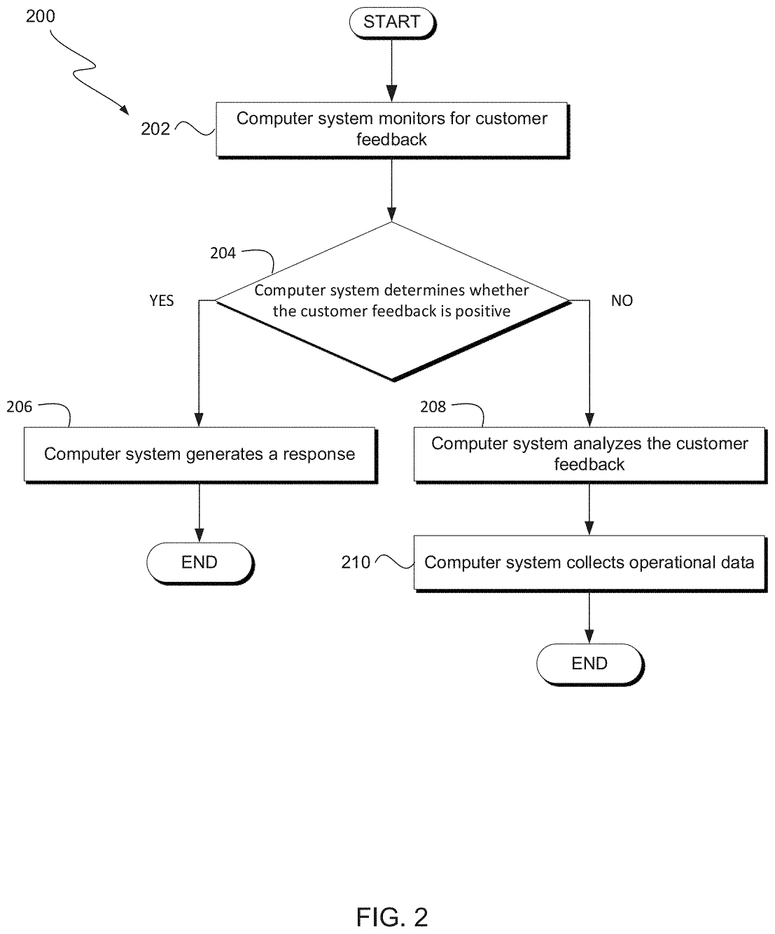

FIG. 2 is a flowchart, 200, depicting operations of operational analytics program 122 in computing environment 100, in accordance with an illustrative embodiment of the present invention. More specifically, FIG. 2, depicts combined overall operations 200 of operational analytics program 122 executing on computer system 120. In some embodiments, operations 200 represents logical operations of server application 132 executing on SAN 130. It should be appreciated that FIG. 2 provides an illustration of one implementation and does not imply any limitations with regard to the environments in which different embodiments may be implemented. Many modifications to the depicted environment may be made. In one embodiment of flowchart 200, the series of operations can be performed in any order. In another embodiment, the series of operations, of flowchart 200, can be terminated in any operation. In addition to the features previously mentioned, any operations, of flowchart 200, can be resumed at any time.

In operation 202, operational analytics program 122 monitors for one or more customer-based reviews (e.g. operational feedback). In various embodiments, operational analytics program 122 receives one or more customer-based reviews from server application 132. Operational analytics program 122 analyzes the one or more customer-based reviews and identifies one or a combination of: (i) the associated commercial product and/or commercial service, (ii) one or more elements of the commercial product or commercial service, (iii) the quality of the feedback (e.g., positive feedback, negative feedback, or neutral feedback), and (iv) the quantitative value of the feedback (e.g., a rating system, ranking system, etc.). In various embodiments, operational analytics program 122 identifies, but is not limited to, (i) the quality and (ii) the quantity of each individual customer-based review. In various embodiments, the feedback associated with the customer-based review can be one or a combination of positive, negative, or neutral feedback.

If operational analytics program 122 determines that the customer-based review is a positive feedback (decision 204, YES branch), then operational analytics program 122 generates a response profile (operation 206). In various embodiments, operational analytics program 122 generates a response profile associated with the positive analyzed customer-based review. In various embodiments, the response profile includes one or a combination of: (i) the customer's online handle, (ii) a message thanking the customer for their patronage, or (iii) a response associated with the content of the customer-based review. In various embodiments, operational analytics program 122 communicates the response profile to server application 132 with a set of program instructions instructing server application 132 to post the response profile to the subsequent public webpage review site. In some embodiments, the set of program instructions instructs server application 132 to communicate the response profile to client device 130.

If operational analytics program 122 determines that the customer-based review is a negative feedback (decision 204, NO branch), then operational analytics program 122 further analyzes the customer-based review (operation 208). In various embodiments, operational analytics program 122 analyzes one or more customer-based reviews. In various embodiments, operational analytics program 122 determines that the quality and quantitative value of the feedback is negative based on, but not limited to, the content of the message. In response to determining that the customer-based review is negative, operational analytics program 122 communicates with server application 132 and requests operational data associated with the customer-based review (operation 210). In various embodiments, operational data includes one or a combination of: (i) video images of the business entity's security cameras, (ii) electronic documents regarding managerial reports, or (iii) financial transactions. In various embodiments of the present invention, operational analytics program 122 leverages the operational data to measure customer quality issues and feedback and measure the current functional state of the business entity and/or store. In various embodiments, operational analytics program 122 analyzes the operational data and compares the customer-based review to the collected operational data.

Embodiments of the present invention recognize that operational analytics program 122 generates a positive response profile in response to decision 204. Additionally, embodiments of the present invention recognize the positive response profile is generated when a customer-based review is identified. In various embodiments, operational analytics program 122 generates the positive response profile based on, but is not limited to, the positive response builder. The response profile includes relevant sensor data (e.g., pictures, wait times, etc.) along with other analytic information that includes, but is not limited to, evaluated to have the highest/best score in view of the negative customer-based review. In various embodiments, the process is fully automated and does not depend on pre-written templates, but the response profile can be generated based on, but is not limited to, business rules established by the business entity or corporation that requires approval or can be modified before responding to the customer-based review.

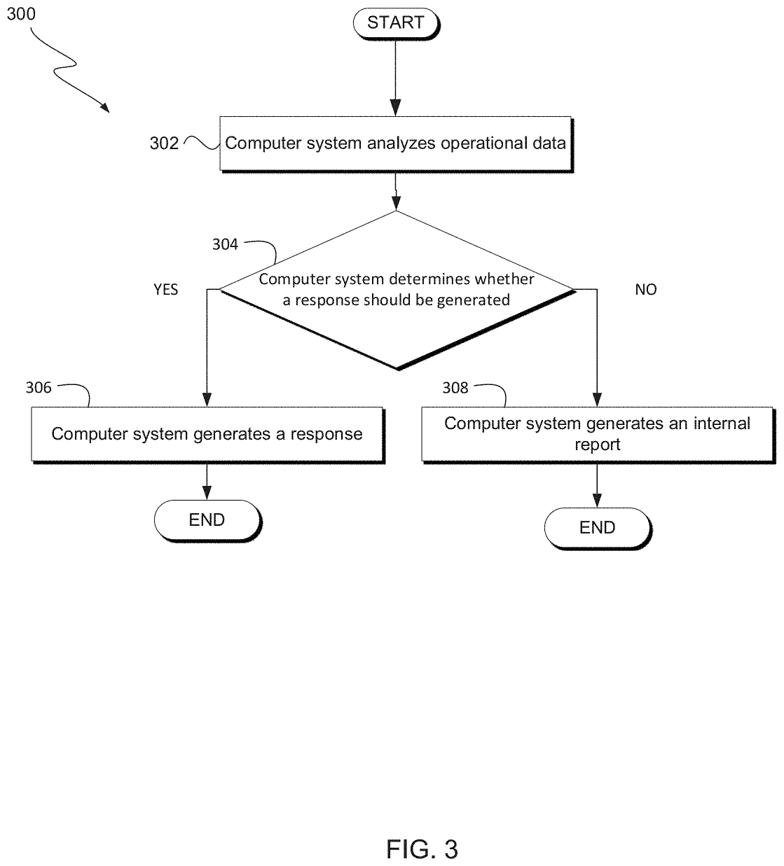

FIG. 3 depicts a flowchart depicting operations for a system for responses to customer-based feedback for computing environment 100, in accordance with an illustrative embodiment of the present invention. More specifically, FIG. 3, depicts combined overall operations, 300, of operational analytics program 122 executing on computer system 120. FIG. 3 also represents interactions between server application 132 and operational analytics program 122. In some embodiments, some or all of the operations depicted in FIG. 3 represent logical operations of server application 132 executing on SAN 130. In various embodiments, the series of operations 300 can be performed simultaneously with operations 200. It should be appreciated that FIG. 3 provides an illustration of one implementation and does not imply any limitations with regard to the environments in which different embodiments may be implemented. Many modifications to the depicted environment may be made. In one embodiment, the series of operations, of flowchart 300, can be performed simultaneously. Additionally, the series of operations, in flowchart 300, can be terminated at any operation. In addition to the features previously mentioned, any operation, of flowchart 300, can be resumed at any time.

In operation 302, operational analytics program 122 analyzes the collected operational data received from server application 132. In various embodiments, operational analytics program 122 identifies data that includes one or a combination of: (i) video images of the business entity's security cameras, (ii) electronic documents regarding managerial reports, or (iii) financial transactions. In various embodiments of the present invention, operational analytics program 122 leverages the operational data to measure customer quality issues and feedback and measure the current functional state of the business entity and/or store. In various embodiments, operational analytics program 122 analyzes the operational data and compares the customer-based review (e.g., operational feedback) to the collected operational data. In various embodiments, operational analytics program 122 determines that the content of the customer-based review is similar to the collected operational data. In some embodiments, operational analytics program 122 determines that an anomaly in the quality of service attribute of the business occurred (e.g., negative experience for a customer).

If operational analytics program 122 determines that a response profile should be generated (decision 304, YES branch)—for example, when the customer-based review is similar to the collected operational data—then operational analytics program 122 generates a response profile associated with the negative analyzed customer-based review (operation 306). In various embodiments, the response profile includes one or a combination of: (i) the customer's online handle, (ii) a message thanking the customer for their patronage, or (iii) a response associated with the content of the customer-based review. In some embodiments, the response associated with the content of the customer-based review includes, but is not limited to, apologizing for the negative experience, a statement on how the business entity has corrected the situation to not occur in the subsequent future, etc. In various embodiments, operational analytics program 122 communicates the response profile to server application 132 with a set of program instructions instructing server application 132 to post the response profile to the subsequent public webpage review site. In some embodiments, the set of program instructions instructing server application 132 to communicate the response profile to client device 130.

If operational analytics program 122 determines that a response profile should not be generated (decisions 304, NO branch)—for example, when the customer-based review (e.g., operational feedback) is not similar to the collected operational data—then operational analytics program 122 generates an internal report (operation 308). In various embodiments, operational analytics program 122 generates an internal report that includes, one or a combination of: (i) the customer-based review, (ii) one or more operational data associated with the customer-based review, and (iii) an analysis of the quality and quantitative value of the negative feedback. Operational analytics program 122 communicates the internal report to an appointed individual responsible for handling customer quality issues. In some embodiments, operational analytics program 122 stores the internal report on database 136 for subsequent use.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned model may include at least five characteristics, at least three service models, and at least four deployment models.

Characteristics are as follows:

On-demand self-service: a cloud consumer can unilaterally provision computing capabilities, such as server-time and network storage, as needed automatically without requiring human interaction with the service's provider.

Broad network access: capabilities are available over a network and accessed through standard mechanisms that promote use by heterogeneous thin or thick client platforms 9 e.g., mobile phones, laptops and PDAs).

Resource pooling: the provider's computing resources are pooled to serve multiple consumer using a multi-tenant model, with different physical and virtual resources dynamically assigned and reassigned according to demand. There is a sense of location independence in that the consumer generally has not control or knowledge over the exact locations of the provided resources but may be able to specify location at a higher level of abstraction (e.g., country, state, or datacenter).

Rapid elasticity: capabilities can be rapidly and elasticity provisioned, in some cases automatically, to quickly scale out and rapidly released to quickly scale in. To the consumer, the capabilities available for provisioning often appear to be unlimited and can be purchased in any quality at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual applications capabilities, with the possible exception of limited user-specific application configuration settings.

Platform as a Service (PaaS): the capability provided to the consumers to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environmental configurations.

Infrastructure as a Service (IaaS): the capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or large industry group and is owned by an organization selling cloud services.

Hybrid cloud: the cloud infrastructure is a composition of two or more cloud (private, community or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

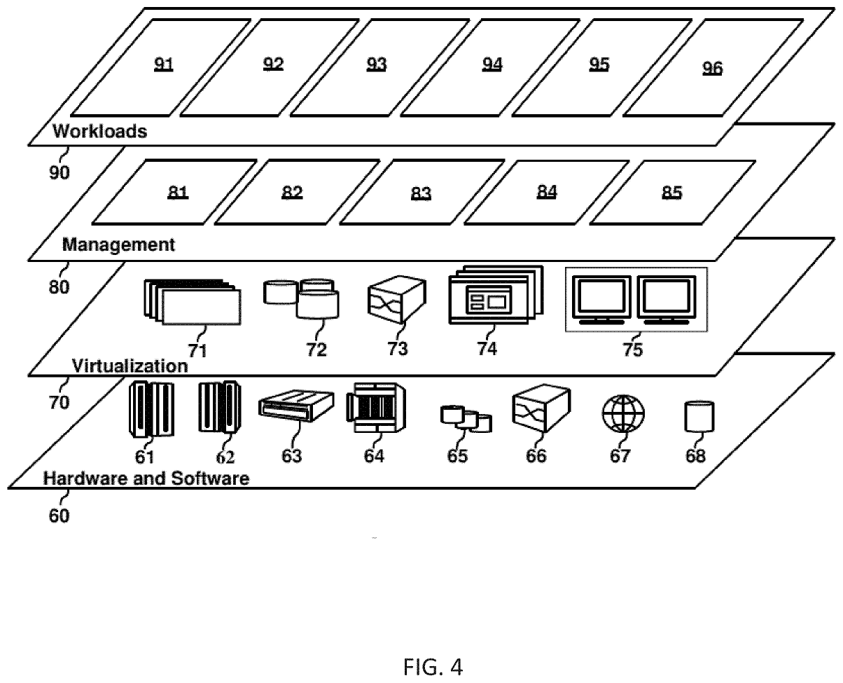

Referring now to FIG. 4, illustrative cloud computing environment 50 is depicted. As shown, cloud computing environment 50 includes one or more cloud computing nodes 10 with which local computing devices used by cloud consumer: such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

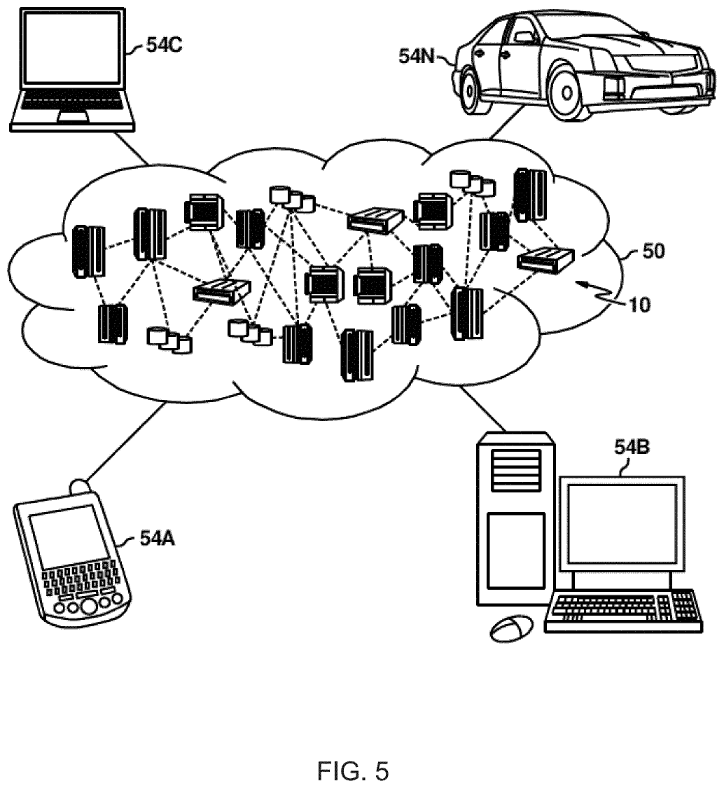

Referring now to FIG. 5, a set of functional abstraction layers provided by cloud computing environment 50 (FIG. 5) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instructions Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73; including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include applications software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 6 depicts a block diagram, 600, of components of computer system 120, SAN 130, client device 140, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computer system 120, SAN 130, client device 140 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Operational analytics program 122, computer interface 124, server application 132, sensors 134, databases 136, client application 142 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 110. In these examples, communications unit 610 includes one or more network interface cards. Communications unit 610 may provide communications through the use of either or both physical and wireless communications links. Operational analytics program 122, computer interface 124, server application 132, sensors 134, databases 136, client application 142 may be downloaded to persistent storage 608 through communications unit 610.

I/O interface(s) 612 allows for input and output of data with other devices that may be connected to computer system 120, SAN 130, client device 140. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., operational analytics program 122, computer interface 124, server application 132, sensors 134, databases 136, client application 142, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method, the method comprising:
identifying, by one or more computer processors, operational feedback directed towards an entity;
determining, by one or more computer processors, a context for the operational feedback, wherein the context includes a plurality of features relating to the operational feedback;
retrieving, by one or more computer processors, operational data associated with the entity, wherein the operational data corresponds to points in time that are within a predetermined time frame of the context;
evaluating, by one or more computer processors, the context and the operational data against a quality of service attribute of the entity; and
generating, by one or more computer processors, a positive response towards the operational feedback based, at least in part, on the evaluating, wherein the context and the operational data are indicative of an anomaly in the quality of service attribute.

2. The computer-implemented method of claim 1, wherein the operational feedback is identified via a cloud-based system that monitors social media channels and public webpage review sites.

3. The computer-implemented method of claim 1, wherein determining the context for the operational feedback comprises:
deconstructing, by one or more computer processors, the operational feedback utilizing a plurality of cognitive services, wherein the cognitive services include: (i) sentiment and tone analysis, (ii) personality insight generation, (iii) natural language processing, and (iv) machine learning.

4. The computer-implemented method of claim 3, wherein the operational data includes security camera data, manager logs, and internal complaint records.

5. The computer-implemented method of claim 4, wherein the evaluating further comprises using machine learning to analyze the context and the operational data to determine whether a quality of feedback of the operational feedback is (i) positive, (ii) negative, or (iii) neutral.

6. The computer-implemented method of claim 5, wherein the evaluating further comprises determining that: (i) the quality of feedback of the operational feedback is positive, and (ii) the context and operational data are indicative of the anomaly in the quality of service attribute.

7. The computer-implemented method of claim 6, further comprising:
identifying, by one or more computer processors, a second operational feedback directed towards the entity;
determining, by one or more computer processors, a context for the second operational feedback, wherein the context for the second operational feedback includes a plurality of features relating to the second operational feedback;
retrieving, by one or more computer processors, additional operational data associated with the entity, wherein the additional operational data corresponds to additional points in time that are within a predetermined time frame of the context for the operational feedback;
evaluating, by one or more computer processors, the context for the second operational feedback and the additional operational data against the quality of service attribute of the entity; and
in response to determining that the context for the second operational feedback and the additional operational data are not indicative of an anomaly in the quality of service attribute, generating, by one or more computer processors, an internal report for the second operational feedback, wherein the internal report is communicated to an individual internal to the entity.

8. A computer program product comprising:
one or more computer-readable storage media and program instructions stored on the one or more computer-readable storage media, the stored program instructions comprising:
program instructions to identify operational feedback directed towards an entity;
program instructions to determine a context for the operational feedback, wherein the context includes a plurality of features relating to the operational feedback;
program instructions to retrieve operational data associated with the entity, wherein the operational data corresponds to points in time that are within a predetermined time frame of the context;
program instructions to evaluate the context and the operational data against a quantity of service attribute of the entity; and
program instructions to generate a positive response towards the operational feedback based, at least in part, on the evaluating, wherein the context and the operational data are indicative of an anomaly in the quality of service attribute.

9. The computer program product of claim 8, wherein the operational feedback is identified via a cloud-based system that monitors social media channels and public webpage review sites.

10. The computer program product of claim 8, wherein the program instructions to determine the context for the operational feedback comprise:
program instructions to deconstruct the operational feedback utilizing a plurality of cognitive services, wherein the cognitive services include: (i) sentiment and tone analysis, (ii) personality insight generation, (iii) natural language processing, and (iv) machine learning.

11. The computer program product of claim 10, wherein the operational data includes security camera data, manager logs, and internal complaint records.

12. The computer program product of claim 11, wherein the evaluating further comprises using machine learning to analyze the context and the operational data to determine whether a quality of feedback of the operational feedback is (i) positive, (ii) negative, or (iii) neutral.

13. The computer program product of claim 12, wherein the evaluating further comprises determining that: (i) the quality of feedback of the operational feedback is positive, and (ii) the context and operational data are indicative of the anomaly in the quality of service attribute.

14. The computer program product of claim 13, the stored program instructions further comprising:
program instructions to identify a second operational feedback directed towards the entity;
program instructions to determine a context for the second operational feedback, wherein the context for the second operational feedback includes a plurality of features relating to the second operational feedback;
program instructions to retrieve additional operational data associated with the entity, wherein the additional operational data corresponds to additional points in time that are within a predetermined time frame of the context for the second operational feedback;
program instructions to evaluate the context for the second operational feedback and the additional operational data against the quality of service attribute of the entity; and
program instructions generate an internal report for the second operational feedback, wherein the internal report is communicated to an individual internal to the entity, in response to determining that the context for the second operational feedback and the additional operational data are not indicative of an anomaly in the quality of service attribute.

15. A computer system, the computer system comprising:
one or more computer processors;
one or more computer readable storage medium; and
program instructions stored on the computer readable storage medium for execution by at least one of the one or more processors, the stored program instructions comprising:
program instructions to identify operational feedback directed towards an entity;
program instructions to determine a context for the operational feedback, wherein the context includes a plurality of features relating to the operational feedback;
program instructions to retrieve operational data associated with the entity, wherein the operational data corresponds to points in time that are within a predetermined time frame of the context;
program instructions to evaluate the context and the operational data against a quality of service attribute of the entity; and
program instructions to generate a positive response towards the operational feedback based, at least in part, on the evaluating, wherein the context and the operational data are indicative of an anomaly in the quality of service attribute.

16. The computer system of claim 15, wherein the program instructions to determine the context for the operational feedback comprise:
program instructions to deconstruct the operational feedback utilizing a plurality of cognitive services, wherein the cognitive services include: (i) sentiment and tone analysis, (ii) personality insight generation, (iii) natural language processing, and (iv) machine learning.

17. The computer system of claim 16, wherein the operational data includes security camera data, manager logs, and internal complaint records.

18. The computer system of claim 17, wherein the evaluating further comprises using machine learning to analyze the context and the operational data to determine whether a quality of feedback of the operational feedback is (i) positive, (ii) negative, or (iii) neutral.

19. The computer system of claim 18, wherein the evaluating further comprises determining that: (i) the quality of feedback of the operational feedback is positive, and (ii) the context and operational data are indicative of the anomaly in the quality of service attribute.

20. The computer system of claim 19, the stored program instructions further comprising:
program instructions to identify a second operational feedback directed towards the entity;
program instructions to determine a context for the second operational feedback, wherein the context for the second operational feedback includes a plurality of features relating to the second operational feedback;
program instructions to retrieve additional operational data associated with the entity, wherein the additional operational data corresponds to additional points in time that are within a predetermined time frame of the context for the second operational feedback;
program instructions to evaluate the context for the second operational feedback and the additional operational data against the quality of service attribute of the entity; and
program instructions generate an internal report for the second operational feedback, wherein the internal report is communicated to an individual internal to the entity, in response to determining that the context for the second operational feedback and the additional operational data are not indicative of an anomaly in the quality of service attribute.
